(19) United States
(12) Patent Application Publication
(10) Pub. No.: US 2014/0375057 A1
(43) Pub. Date: Dec. 25, 2014

(54) ARTIFICIAL WIND GENERATOR

(71) Applicant: GAURAV BAZAZ, EDGEWATER, NJ (US)

(72) Inventor: GAURAV BAZAZ, EDGEWATER, NJ (US)

(21) Appl. No.: 14/311,350

(22) Filed: Jun. 23, 2014

Related U.S. Application Data
(60) Provisional application No. 61/838,323, filed on Jun. 23, 2013.

(51) Int. Cl. F01D 1/00; F01D 15/10

(52) U.S. Cl. CPC F01D 1/00; F01D 15/10; Y02E 10/465
USPC 290/52

(57) ABSTRACT

A method is provided for generating power through artificially induced wind flow. Naturally available energy such as sunlight is used to create high and low air pressure areas artificially in two separate chambers or regions. The two areas are connected together through a tube, which results in wind flow from the higher air pressure area to the lower air pressure area, which wind flow is used to power wind turbines which in turn generate electric power. The method provides an alternative to existing methods for power generation from wind energy or solar energy, such as natural wind farms, photovoltaic cells and solar-thermal systems.

### RELATED APPLICATION

This application claims the benefit of priority to U.S. Provisional Application 61/838,323 filed 23 Jun. 2013, the entire disclosure of which is incorporated by reference.

### SUMMARY OF INVENTION

Existing methods for generating energy from wind flow rely on natural flow of wind to power a wind turbine which in turns generates electricity. However, this method depends on consistent flow of wind at reasonable velocities to generate power. In addition, the smoothness of wind flow (lack of turbulence) is required to produce efficient conversion of kinetic energy of wind into electricity. This method suffers from dependence on natural forces of nature with unpredictable tendencies and inconsistent availability. In addition, wind farms consisting of many such wind turbines can only be economically located in certain geographical locations where natural wind flow is consistent and ample.

The present invention eliminates or mitigates most of these core problems with natural wind driven wind turbines by generating wind artificially within a closed setup within which the flow of wind is utilized to generate electric power using wind turbines.

As used herein, a Low Pressure Chamber refers to a partially enclosed chamber which has lower air pressure compared to another chamber or atmospheric region to which it is connected through a channel or tube.

As used herein, a High Pressure Chamber refers to a partially enclosed chamber which has higher air pressure internally compared to the Low Pressure Chamber as described above.

As used herein, a Wind Channel is a channel or a tube that connects the Low Pressure and High Pressure Chambers as described above. The Wind Channel has wind turbines placed within it as well.

As described herein, in one of various embodiments, the device consists at the minimum of a Low Pressure Chamber, a High Pressure Chamber, a Wind Channel connecting the high pressure and Low Pressure Chamber and a single or plurality of wind turbines placed in the Wind Channel or near its end points.

In one of various embodiments, the device operates as follows. The Low Pressure Chamber is exposed to some source of heat energy, ideally solar energy in the form of natural sunlight from the sun which heats up the air in the Low Pressure Chamber. The Low Pressure Chamber is designed to collect and absorb heat energy very efficiently so that most of heat energy such as solar energy that is delivered to it is used up in heating the air within the chamber and very limited amount is reflected. This is done using various methods and technologies such as light collecting reflector mirrors to concentrate sunlight and black painted walls to absorb the solar rays and prevent reflection. Similarly, the spatial geometry of the chamber is designed to maximize the rate at which air is heated within the chamber. The heating of air causes the air to rise and migrate out of the chamber. The chamber is designed so that it can be maintained at considerably lower pressure than atmospheric pressure. One such design would consist of a glass ceiling from where sunlight is taken into the chamber and darkened walls that capture and hold the heat. Similarly metal plates may be placed within the chamber that efficiently absorb heat from the sun and transfer it to the air within the chamber. The ceiling has small exhausts ducts from where the hot air from within the chamber is allowed to escape through valves that allow only outflow and no inflow of air.

The High Pressure Chamber on the other hand is insulated from heat which allows the air within it to be maintained at near atmospheric pressure for the given altitude. The High Pressure Chamber may be a partially enclosed chamber where direct sunlight is prevented from entering, so the space within the chamber is not heated by sunlight, like the Low Pressure Chamber. If we are using an alternative heat source, other than sunlight, then the High Pressure Chamber may be protected from this heat source. In another embodiment, the High Pressure Chamber is removed entirely and the general environmental surroundings of the Low Pressure Chamber are used in place of a High Pressure Chamber. In this case the general surroundings (atmosphere) act as the High Pressure Chamber.

As the air is heated in the Low Pressure Chamber by the capture of sunlight, it exits the chamber thereby creating low pressure in this chamber. Since the Low Pressure Chamber is connected through the Wind Channel to the High Pressure Chamber (or a general region of high pressure), we find a pressure imbalance between the Low Pressure Chamber and the high pressure region. The Wind Channel is simply a pipe or tube connecting the High Pressure Chamber to the Low Pressure Chamber. As a result, wind flows from the high pressure region to the Low Pressure Chamber through the Wind Channel. Wind turbines placed within or near the Wind Channel are driven to rotate by this wind flow, which in turn are connected to generators which generate electric energy. The air within the Low Pressure Chamber is heated continuously by the sunlight, or an alternative heat source, so that it is continuously evacuated from the Low Pressure Chamber. As more air flows out of the Low Pressure Chamber, more air is drawn from the high pressure regions so that we get almost continuous wind flow through the Wind Channel. This continuous wind flow runs through the wind turbines, which in turn generates electric power. Therefore, this device engineers artificial wind flow using natural energy sources, which in turn is harnessed to generate electric power. Natural wind driven wind farms also operate on the same underlying energy transfer, however, they rely on natural air pressure imbalances across topographical regions to get their wind flow and are dependent on favorable climactic conditions to receive their wind flow. In this invention, we have eliminated the dependence on natural climactic wind flow, and have instead created a method for generating artificial wind flow in any geographical region using natural sunlight.

Using the above system, we are able to create smooth and consistent wind flow through the Wind Channel. We can leverage this artificially created wind flow to power a turbine placed within or near the ends of the Wind Channel. As the artificially created wind blows through the Wind Channels, it will drive the wind turbine, which is connected to a generator through a shaft and which in turn generates power. The size of both chambers is calculated so that the rate at which air is heated and evacuated from the Low Pressure Chamber is such that a consistent flow of wind can be maintained in the Wind Channel.

Advantages:
a. This model allows wind power to be created anywhere so wind power is no longer geographically confined
b. It is very environmentally friendly as it requires no fuel except a natural source of heat energy such as sunlight and doesn't use up large tracts of land
c. Since we create artificially engineer wind flow—we can precisely control the speed and volume of the wind flow to optimize the efficient capture of the kinetic energy of the flow
d. We can get consistent and predictable energy from this model, unlike traditional wind power, since we no longer depend on naturally generated wind
e. The wind flow in the Wind Channel is smooth since the wind is artificially generated within an enclosed chamber and transported through tubes, which allows for very efficient operation of wind turbines unlike traditional wind power where air flow is turbulent which considerably reduces turbine efficiency.

Variations:

The present invention can be implemented in other models as well, while staying within the scope of the current disclosure. The description of the embodiment provided herein, is not limiting and other implementations applying the same concept of artificially generated wind flow are possible within the scope of the current invention.

### BRIEF DESCRIPTION OF DRAWINGS

FIG. 1 provides a high level description of the concept with two chambers and an interconnecting tube.

FIG. 2 provides a high level view of the interconnecting tube with a see through view of some interior components.

FIG. 3 provides a high level view of another an embodiment of the Low Pressure Chamber with a glass roof.

FIG. 4 provides high level description of another embodiment of the concept wherein the two chambers are replaced with a single chamber and the general environment of the single chamber provides the high pressure region, while the single chamber acts as the low pressure region.

### DETAILED DESCRIPTION OF THE DRAWINGS

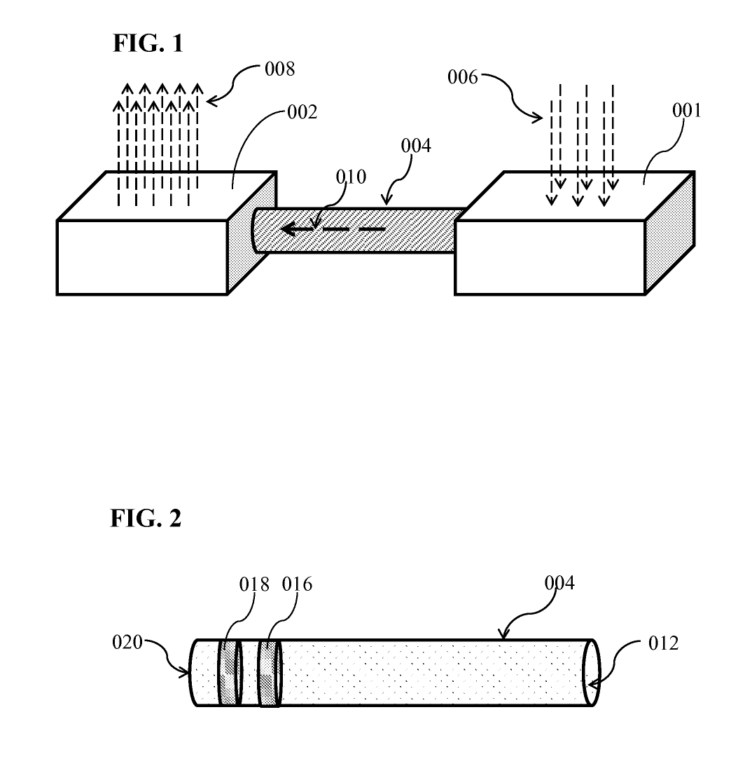

FIG. 1 shows a high level highly simplified view of the concept. The system consists of a High Pressure Chamber 001, a Low Pressure Chamber 002 and an interconnecting tube 004. A wind turbine with a generator is embedded within the interconnect tube 004, which is not shown here. Solar heat in the form of sun rays heat up air in Low Pressure Chamber 002 which is designed to absorb the maximum amount of energy from the sun. This is be done by having a glass roof and black painted walls which allow high level of capture of solar heat. Additional heat trapping materials may be used inside the chamber to maximize the capture of heat from sunlight. As the air in the chamber heats up, it rises up and escapes from the chamber as shown by 008, through exhaust ducts (not shown). As a result low pressure is created in chamber 002. At the same time chamber 001 is designed to absorb as little energy as possible from the sun. This can be done by having a closed chamber where no sunlight is allowed to enter directly and inlet ducts along the walls allow atmospheric air to enter the chamber and replenish the air supply when air is drawn from this chamber. As a result the air within this High Pressure Chamber stays cool and the chamber maintains a relatively higher pressure. The pressure imbalance between the two chambers, with one chamber 002 at low air pressure and other chamber 001 at relatively higher pressure, results in the air migrating from the High Pressure Chamber 001 to the Low Pressure Chamber 002 to equalize the pressure in the two chambers, through the interconnect tube 004. This results in more air 006 being drawn into the High Pressure Chamber 001 to fill the space vacated by the air drawn into the Low Pressure Chamber. The air flow 010 through the interconnect tube constitutes artificially created wind flow which can be utilized to drive a wind turbine. Wind turbines placed within Wind Channel 004 rotate as the artificially created wind flows through, and generate electric power.

FIG. 2 describes the Wind Channel (interconnect tube) in little more detail, with a see-through view of the tube 004. Wind enters the tube from the high pressure region at 012 and exits the tube into the low pressure region at 020. Wind turbines 018 and 016 are placed within the tube and are driven by the wind within the tube to generate electric power.

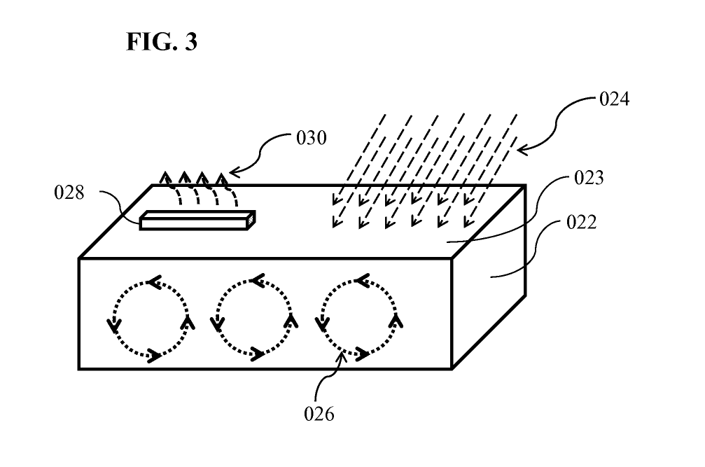

FIG. 3 describes an embodiment of the Low Pressure Chamber in detail. The chamber 022 consists of a glass roof 023 through which sunlight 024 enters the chamber. The chamber is enclosed except for a vent 028. The heat from the sunlight heats up the air within the chamber which circulates within the chamber as shown in 026. However, as the air heats up, it rises up and exits the chamber through the vent 028 as hot air 030. The vent 028 has valves which allow only outflow of air and no inflow into the chamber. This results in low pressure within the chamber.

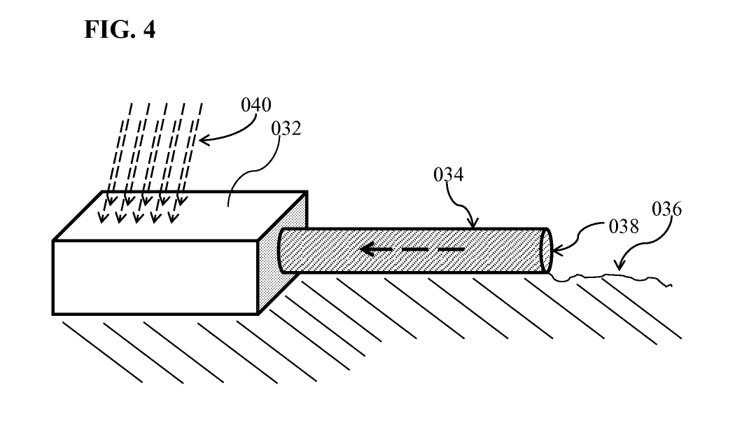

FIG. 4 describes an alternative model for the concept wherein we only have a single chamber, a Low Pressure Chamber, and the High Pressure Chamber is replaced with the general environment of the Low Pressure Chamber. Here the Low Pressure Chamber 032 is built on the ground 036 with inlet tube 034 through which air from the general environment can enter the chamber. The chamber heats up the air internally using the solar heat 040 from the sun which is trapped in the chamber, which causes air to exit this chamber resulting in low pressure in the chamber. The surrounding environment is at a higher air pressure and therefore air from the surrounding environment enters the chamber through the inlet tube 034 at the inlet point 038 and drives wind turbines placed within the inlet tube (not shown here). These turbines in turn generate electric power converting the wind's kinetic energy to electric energy.

1. An apparatus for generating electrical energy through the artificial initiation and maintenance of wind flow in an enclosed system wherein a natural energy source is used to create pressure differences in two chambers, the system essentially comprising of:
a. a low pressure chamber which contains air and is exposed to a natural source of heat
b. a high pressure chamber which contains air and is protected from heat
c. a wind channel which connects said low pressure chamber and high pressure chamber such that wind flows from said high pressure chamber to said low pressure chamber
d. a means to convert wind energy to electric energy placed inside said wind channel or near its points of connection with said high pressure chamber or low pressure chamber
whereby a region of low air pressure is created in said low pressure chamber by the process of heating, and said high pressure chamber is maintained at comparatively higher pressure relative to said low pressure chamber, thereby urging wind flow from high pressure chamber to low pressure chamber, which wind flow is converted to electric energy by a means to convert kinetic energy of wind to electric energy.

2. The apparatus of claim 1 wherein said natural source of heat is sunlight.

3. The apparatus of claim 1 wherein said means to convert wind energy to electric energy is a conventional wind turbine and generator configuration.

4. The apparatus of claim 1 further including a plurality of high pressure chambers and a plurality of low pressure chambers, a plurality of wind channels and al plurality of means to convert wind energy to electric energy.

5. The apparatus of claim 1 wherein said low pressure chamber comprises of an enclosed region containing air with glass ceilings which allow sunlight to enter; floors and walls consisting of heat absorbing materials; and outlets from where hot air is released through valves that only allow outflow of air and no inflow.

6. The apparatus of claim 1 wherein said high pressure chambers comprise of an enclosed region which is protected from heat including sunlight, and has floors and walls made of heat dissipating materials such that the air within the chamber is cooled and therefore maintained at higher pressure relative to said low pressure chamber.

7. The apparatus of claim 1 wherein said wind channel is a tube or a pipe or a tunnel that links a single or plurality of high pressure chambers to a single or plurality of low pressure chambers, allowing wind to flow from said high pressure chambers to said low pressure chambers, and has within its interior cavity or close to its end points in said low pressure or high pressure chambers a single or series of wind turbines which are driven by the flow of artificially generated wind through said wind channel, which turbines are connected to generators such that when said turbines are driven by said wind flow, electric energy is produced by said generators.

8. An apparatus and method for generating electrical energy through the artificial initiation and maintenance of wind flow in a partially enclosed system wherein a natural energy source such as heat from sunlight is used to create a low pressure region in an enclosed chamber and a tube is connected to the surroundings of said chamber, such that the relatively higher pressure air from outside said chamber is drawn into said chamber through said tube, resulting in generation of wind flow in said tube.

9. The apparatus of claim 8 wherein wind turbines operatively connected to electric generators are placed within the inner cavity of said tube so that that artificially generated wind flow runs through said turbines, thereby rotating blades of said turbine, which in turn drives said generator which generates electrical power.
